(19) United States
(12) Patent Application Publication
(10) Pub. No.: US 2023/0372067 A1
(43) Pub. Date: Nov. 23, 2023

(54) DENTAL IMPLANT FOR PRESERVING BONE AND IMPROVING OSSEOINTEGRATION

(71) Applicant: Dustin Shin, Carlsbad, CA (US)

(72) Inventor: Dustin Shin, Carlsbad, CA (US)

(21) Appl. No.: 17/750,036

(22) Filed: May 20, 2022

(51) Int. Cl. A61C 8/00

(52) U.S. Cl. CPC A61C 8/0025; A61C 8/0072; A61C 8/0075; A61C 8/0012; A61C 8/0068

(57) ABSTRACT

The present invention relates to an advancement in dental implants procedures where a novel from of double threaded dental implant structure is disclosed. The proposed assembly's large thread pitch allows better stability and reduces the stress on associated tissues and organs.

### CROSS-REFERENCE TO RELATED APPLICATIONS

This application claims the benefit of priority under 35 U.S.C. § 119(e) of co-pending U.S. Provisional Patent Application No. 63/318,793 filed Nov. 3, 2022, entitled “Dental Implant for preserving bone and Improving Osseointegration.” The disclosure of the above-referenced application is incorporated herein by reference.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The invention relates generally to the field of dentistry, and more particularly to the field of dental restorations, implants, and prostheses. The invention further relates to an improvement in implant procedures with its double threaded approach.

### Description of the Related Art

Human teeth have a variety of functions, such as chewing food and the pronunciation of certain consonants, such as “s”-sounds and fizzle-sounds. Additionally, human teeth play a major role in one's personal appearance because healthy and well-aligned teeth are models of beauty and a sign of youth and success.

The main goal of dentistry is to prevent the loss of teeth as long as possible. Another goal is to provide a prosthesis for comfortability and longevity of functions.

There are limited available restorative and prosthetic options, such as fillings, inlays, and crown, but they are used if the root and the surrounding periodontal structure are healthy. If the original tooth is inoperable, then bridges and/or non-customized Osseo integrated implants are recommended. For bridges, the adjacent teeth need to provide a support structure. Osseo integrated implants are invasive and can lead to gum and bone loss over time leading to infections. All these options listed have a limited average lifetime.

Another option is to replace the tooth with an implant. A damaged tooth, due to caries or mechanical impact, should be replaced. If the tooth continues to have structural strength, then a prosthesis is recommended. However, a severe tooth loss may require a bridge or an Osseo integrated implant.

Off-the-shelf or pre-shaped Osseo integrated dental implants are one of the options. Osseointegration is the contact between the implant and the bone excluding the fibrous connective tissue interface. There are wide varieties of implant designs and materials when using dental implant depending on the location and the surgical protocols.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract.

The present invention seeks to improve upon prior dental implant processes and to perform the designated functionality in secure and advance way.

Another object of the present invention is to provide a large thread pitch that helps in reducing the stress in the cortical bone when being inserted into the mandible bone.

It is a further objective of the present invention to provide a large thread depth helps with primary stability of the implant.

It is further the objective of the invention to provide comparatively small and easy to perform the implant process and aims to reduce the time of the operation and minimized the effort.

It is also the objective of the invention to provide an assembly which increases control over the surgical site and enhances both the speed and quality of the entire procedure

It is also the objective of the invention to provide a whole construction which is compatible with high volume manufacturing methods for all of the components. The low manufacturing cost means that this high-quality portable instrument may be made available to hospitals and clinics that may otherwise not be able to afford a quality instrument. It also makes the assembly highly applicable to the developing world and exposes a wider public audience to firsthand scientific advancements.

Thus, it is the objective to provide a new and improved form of an advancement in a dental implant process. Other aspects, advantages and novel features of the present invention will become apparent from the detailed description of the invention when considered in conjunction with the accompanying drawings.

This Summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1—shows the perspective side view of the implant as per preferred embodiments of the invention.

FIG. 2—shows top view of implant as per preferred embodiments of the invention.

FIG. 3—shows the cross-sectional view of implant as per preferred embodiments of the invention.

FIG. 4—shows the side view of implant embedded into the bone showing that there are no threads cutting the cortical bone as per preferred embodiments of the invention.

FIG. 5—shows the side view of the implant with cortical bone is not fully embedded into the bone and large thread only cuts through the cortical bone once as per preferred embodiments of the invention.

FIG. 6—shows two implants, one of the dental implants of FIG. 1 and the other being a standard implant used in most implant systems, for side-by-side comparison to emphasize the size of the thread depth

FIG. 7—shows an upper view of both partially embedded and embedded dental implant of FIG. 1

FIG. 8—shows an upper view of both partially embedded and embedded standard implant shown in FIG. 6

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

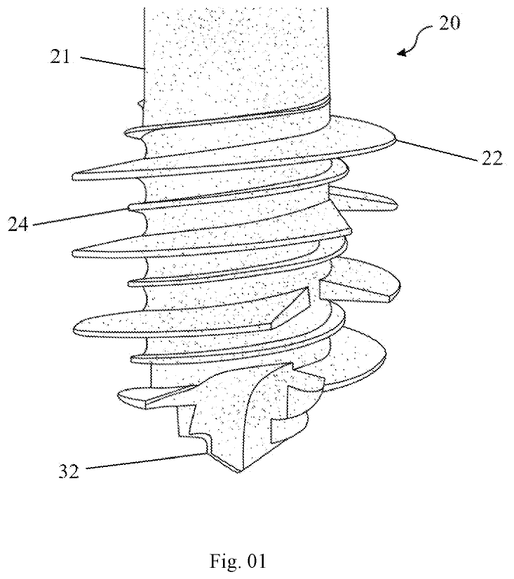

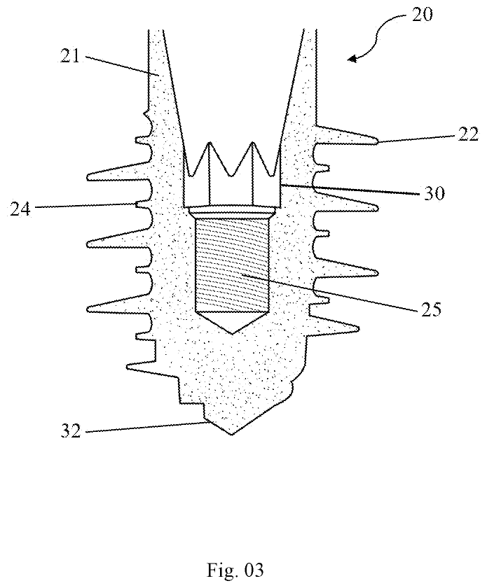

Referring to FIG. 1, the present invention dental implant 20 has a tapered shape. Implant 20 includes a core 27 that is made of a biocompatible material, such as titanium. The body of implant 20 is composed of a tapered apical end 32, a large macro thread 22, a neck 21, and a small micro thread 24. FIG. 3, shows a cross-sectional view of implant 20, where the core 27 includes an abutment interface structure, shown as an internal hex 30 and an internally threaded bore 25.

The tapered apical end 32 means that there are two indents at the apical end of the implant. The taps of implant 20 extend from the last macro thread 22 to the end of implant 20. Different embodiments include different taps extending at different lengths of implant 20. The purpose of the tapered apical end 32 is to mimic the shape of the natural tooth roots, which helps with the primary stability and decreases the risk of perforation preventing infection and micromotion. The tapered apical end 32 condenses the cancellous bone 62 allowing for high insertion torque and primary stability. Due to the ability of tapered apical end 32 to produce high insertion torque and primary stability, implant 20 can be immediately loaded into a patient meaning that a prosthesis can be placed on implant 20 within 48 hours rather than 6 months to wait for the bone to completely heal.

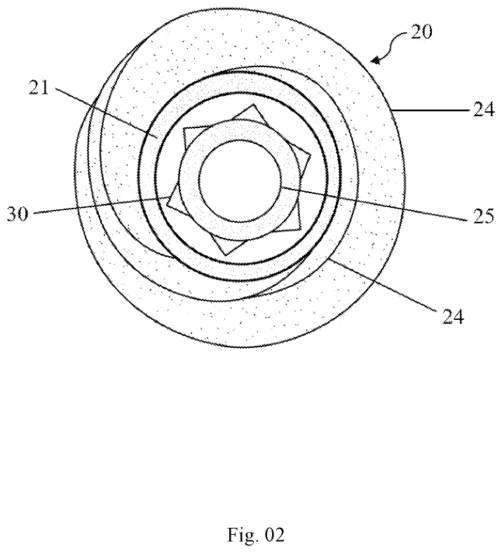

The macro thread 22 and the micro thread 24 extend from the apical end of the neck 21 to the apical end of implant 20, creating a double-threaded design. As seen in both FIG. 1 and FIG. 2, the macro thread 22 of implant 20 has a deep thread depth meaning that the thread extends outwards at approximately 1.5 mm. The purpose of the macro thread 22 is to ensure the primary stability in the cancellous bone 62 by increasing the surface area for bone-to-implant contact and the insertion torque of implant 20. Increasing the surface area for bone-to-implant contact is important because it helps with osseointegration, meaning that the bone can fuse with implant 20 allowing for better stability. Although studies have shown that large thread depth on dental implants causes an increase in bone density, smaller thread width will help reduce the stress concentration. Thread pitch is the length between each macro thread. The micro thread 24 is not considered when measuring the length of the thread pitch. The thread width of the macro thread 22 is thin. The macro thread 22 can be seen as a knife as it is large and thin allowing it to cut easily through the cortical bone 60 preventing an increase in stress concentration in higher bone density areas, like the cortical bone 60.

To help improve osseointegration, the micro thread 24 increases the surface area and primary stability in the cancellous bone 62. The micro thread 24 has a much smaller thread depth than the macro thread 22 having a depth of approximately 0.3 mm. Having an extra thread may cause an increase in stress concentration in the cortical bone 60, but small thread like the micro thread 24 will have little to no effect on the stress concentration of the cortical bone 60 and the cancellous bone 62.

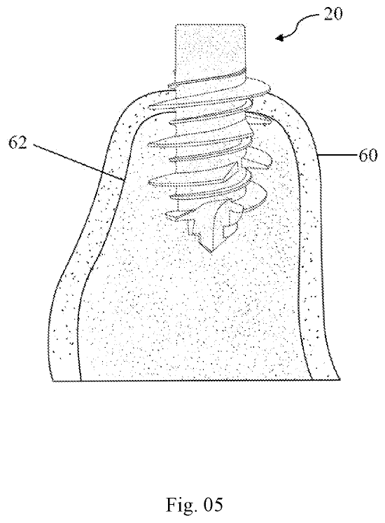

A large thread pitch can be seen in implant 20, as seen in FIG. 1 and FIG. 5. Implant 20, in FIG. 5, is not fully embedded into the implant to show how the large thread pitch allows the macro thread 22 to penetrate through the cortical bone 60 once to minimize the stress in the cortical bone 60 and reduce the loss of cortical bone when inserting implant 20. Due to the high bone density of the cortical bone in patients, inserting a large thread, like the macro thread 22 of the implant 20, can lead to high stress concentration, which is the reason why the thread pitch is large, so that the macro thread 22 minimizes the contact of the macro thread 22 to the cortical bone 60. The length of the thread pitch is determined by the average cortical bone thickness of the mandible bone. In different embodiments of implant 20, the thread pitch will accommodate the patient's cortical bone thickness using cone beam computed tomography software to accurately measure the thickness of the cortical bone 60. On a computed tomography scan, the cortical bone can be seen as a dense white layer surrounding a hollow shape. The hollow part of the bone is the cancellous bone 62. Only the dense white layer of the edentulous location on the posterior and anterior mandible bone is measured to determine the thickness of the cortical bone.

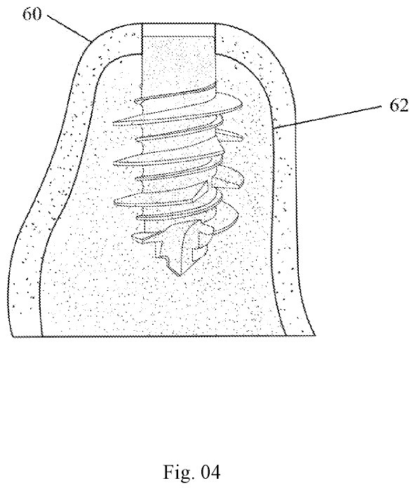

In FIG. 4, implant 20 is shown embedded into the mandible bone of the host. In higher bone density, the cortical bone 60, thread depth and pitch are put into consideration because large thread depth and narrow thread pitch can lead to high stress concentration. After the insertion of the implant 20, the neck 21 is the only part of implant 20 in the cortical bone replacing the thread 22 in the cortical bone 60 with a smooth part of the implant 20. The neck 21 does not include threads in the cortical bone 60 because threads cause stress in high density bone leading to bone absorption and complications in the bone, such as micromotions of the implant and infections in the gum or bone. The thin and smooth neck 21 also causes minimal marginal gingival change based on the biologic ratio of supra-implant. Having marginal gingivitis means gum recession and bone recession due to improper implant placement and implant design, which can lead to esthetic issues and implant failures. The average biologic height-width ratio of the supra-implant mucosa, the gum around the prosthesis and the implant, is 1:1.5 meaning that the ratio is optimal for providing a stable buccal cervical line, the curved base of the prosthesis. The neck 21, when viewed from the top, referring to FIG. 2, has a slight oval shape. The goal of the oval shape of the neck 21 is to create space between the cortical bone 60 and the implant 20, which lowers the stress concentration in the bone and allows the bone to heal successfully over the neck 21. The purpose of the neck 21 is to minimize the stress added to the cortical bone, so that the healing period is shortened, and prevent recession of the gum averting undesirable cosmetic faults.

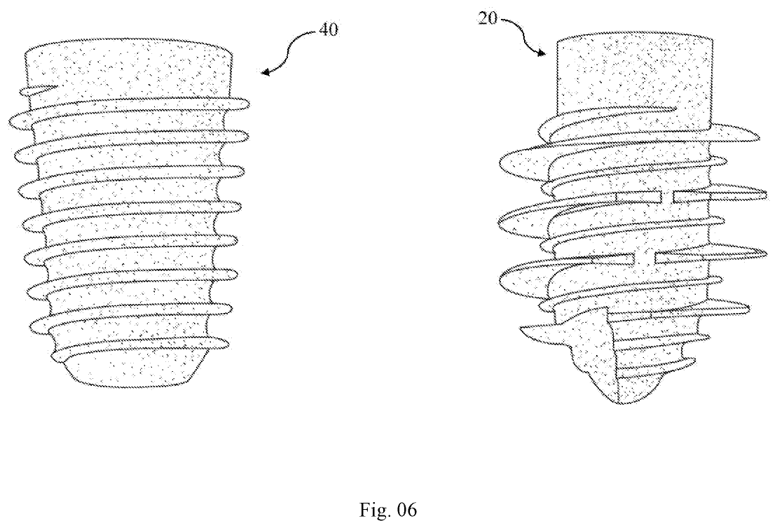

In FIG. 6, two implants are shown to compare the different designs of the implants. The left implant 40 is the average implant design for most implant systems that are usually single threaded with a small thread depth throughout the body of the implant. The right implant 20 is the present invention. As seen in FIG. 6, the standard implant 40 does not include a smooth thin neck, which can lead to a high concentration in high density bone, such as the cortical bone. It also does not have a large thread depth and pitch preventing maximum primary stability of the implant when embedded into the cancellous 62 and cortical bone 60. Another big difference between the two implants is the shape of the body. The body of the standard implant 40 gets thinner and thinner towards the apical end, while the present invention 20 only has a conical end 32 at the apical end of the body. The purpose of this body design for the present invention is to allow for the osteotomy, the drill hole created for the insertion of the implant, for the implant 20 to be smaller than the osteotomy needed for implant 40, so that the implant 20 can fit perfectly into the osteotomy allowing bone to be preserved and implant 20 to be stable with inserted. On the other hand, the osteotomy needs to be larger for the standard implant 40 because the neck of the implant is larger than the apical end due to the shape of the body. This can lead to micromotions of the implant and failed bone recovery during the healing period.

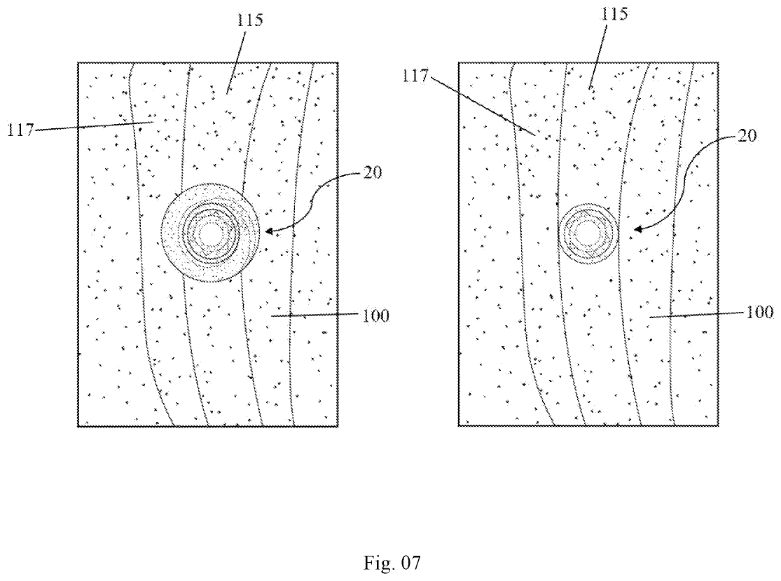

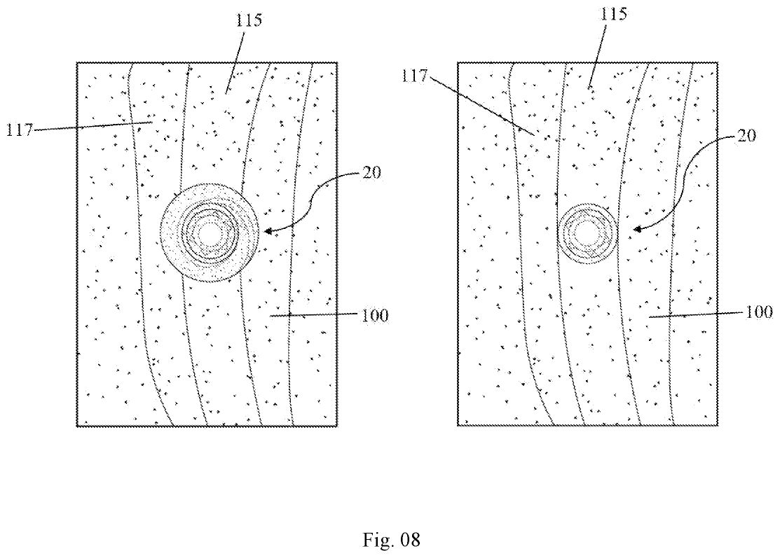

FIG. 7 shows the aerial view of an implant being inserted into the posterior mandible bone 115 of the host. First showing the implant 20 not fully embedded into the bone 60 to emphasize the size of the macro thread 22 before entering the bone 115. Then, on the right, showing implant 20 fully embedded into the bone to show that the macro thread 22 disappears into the bone 60 showing how the buccal bone 117 and the lingual bone 100 are untouched and undamaged. The purpose of this demonstration is to show that the macro thread 22 hides itself into the bone after being inserted into a small osteotomy. The macro thread 22 ensures maximum primary stability by increasing the surface area of the implant for bone-to-implant contact and preventing any implant complications. FIG. 8 shows the top view of a standard implant 40 being inserted and there is no difference in the fully embedded implant 40 and the partially embedded implant 40. Although the buccal bone 117 and the lingual bone 100 are untouched and undamaged, the standard implant 60 does not show how the threads of the implant can obtain primary stability in the cortical bone 60. The purpose of this comparison between the invention dental implant 20 and the standard implant 40 is to demonstrate the ability of the macro thread 22 to obtain primary stability in the bone 60.

We claim:

1. A dental implant, comprising:
a body made of porous metal, which improve bone-implant contact when fully engaged into a jaw of the patient, wherein said porous metal is extended throughout the entire said body; wherein said body has an apical part with at least two taps located on opposite ends of said apical part extending to first thread of said body; wherein said threads consists of two thread depths, a macro thread and a micro thread, extending from an apical part to an apical end of said neck of said body; wherein said neck of said body is composed of porous metal and does not consist of said threads.

2. The dental implant as per claim 1, further comprising the double threaded design of the macro thread and the micro thread.

3. The dental implant as per claim 2, wherein the thread depths of the macro thread are approximately the same throughout the implant.

4. The dental implant as per claim 2, wherein the thread depths of the macro thread are approximately 1.5 mm.

5. The dental implant as per claim 2, wherein the thread depths of the micro thread are approximately the same throughout the implant.

6. The dental implant as per claim 2, wherein the thread depths of the micro thread are approximately 0.3 mm.

7. The dental implant as per claim 1, wherein the apical end includes two taps on opposite ends of said apical end.

8. The dental implant as per claim 1, further comprising said neck that is approximately the same size as the body of the implant.

9. As per claim 10, the neck extends towards the apical end of approximately 1 mm.

10. As per claim 10, the neck takes the shape of an oval when viewed from above.

11. The dental implant as per claim 1, further comprising a large thread pitch based on the average thickness of the cortical bone of about ˜1.5 mm.
